(19) United States
(12) Patent Application Publication
(10) Pub. No.: US 2013/0273355 A1
(43) Pub. Date: Oct. 17, 2013

(54) DICING DIE BONDING FILM

(71) Applicants: Dong Seon UH, Uiwang-si (KR); Ji Ho KIM, Uiwang-si (KR); Min Kyu HWANG, Uiwang-si (KR); Kyung Rae CHO, Uiwang-si (KR); Ki Tae SONG, Uiwang-si (KR)

(72) Inventors: Dong Seon UH, Uiwang-si (KR); Ji Ho KIM, Uiwang-si (KR); Min Kyu HWANG, Uiwang-si (KR); Kyung Rae CHO, Uiwang-si (KR); Ki Tae SONG, Uiwang-si (KR)

(21) Appl. No.: 13/919,149

(22) Filed: Jun. 17, 2013

Related U.S. Application Data
(63) Continuation of application No. PCT/KR2011/005899, filed on Aug. 12, 2011.

(30) Foreign Application Priority Data
Dec. 17, 2010 (KR) 10-2010-0130084

(51) Int. Cl. C09J 7/02

(52) U.S. Cl. CPC C09J 7/0217
USPC 428/335; 428/354; 428/355 R

(57) ABSTRACT

A pressure sensitive dicing die bonding film includes a base film, a pressure sensitive adhesive layer formed on the base film, and a bonding layer formed on the pressure sensitive adhesive layer. An adhesive strength between the pressure sensitive adhesive layer and the bonding layer and an adhesive strength between the pressure sensitive adhesive layer and a ring frame may satisfy the following relation:

B/A≧1.1

where A is the adhesive strength between the pressure sensitive adhesive layer and the bonding layer, and B is the adhesive strength between the pressure sensitive adhesive layer and the ring frame.

### CROSS-REFERENCE TO RELATED APPLICATIONS

This application is a continuation of pending International Application No. PCT/KR2011/005899, filed on Aug. 12, 2011, and entitled “Dicing Die Bonding Film,” which is incorporated by reference herein in its entirety.

This application claims priority under 35 U.S.C. §119 to Korean Patent Application No. 10-2010-0130084, filed on Dec. 17, 2010, in the Korean Intellectual Property Office, and entitled: “Dicing Die Bonding Film,” which is incorporated by reference herein in its entirety.

### BACKGROUND

1. Field

Embodiments relate to a pressure sensitive dicing die bonding film.

2. Description of the Related Art

A general dicing film is subjected to an additional process for bonding individual chips after wafer dicing to a support member, such as a PCB or a lead frame, in order to communicate electrical signals to the chips. For communication of the electrical signals, a liquid epoxy resin is introduced on the support member and the individual chips are bonded thereto. As a result, the chips are bonded to the support member through the epoxy resin. This process involves the two processing steps, which may increase cost and/or decrease yield. Thus, a dicing die bonding film may be used.

### SUMMARY

Embodiments are directed to a pressure sensitive dicing die bonding film, including a base film, a pressure sensitive adhesive layer formed on the base film, and a bonding layer formed on the pressure sensitive adhesive layer. An adhesive strength between the pressure sensitive adhesive layer and the bonding layer and an adhesive strength between the pressure sensitive adhesive layer and a ring frame may satisfy the following relation:

B/A≧1.1

where A is the adhesive strength between the pressure sensitive adhesive layer and the bonding layer, and B is the adhesive strength between the pressure sensitive adhesive layer and the ring frame.

The pressure sensitive adhesive layer may has a shift distance of 0 mm to 0.1 mm in a creep test when a force of 10 gf/mm² is applied thereto for 1,000 seconds.

The pressure sensitive adhesive layer may have a monolayer structure.

The pressure sensitive adhesive layer may have a thickness of 3 μm to 40 μm.

The pressure sensitive adhesive layer may include a silane coupling agent.

The silane coupling agent may be present in an amount of 0.1 to 5% by weight, based on a solids content of the pressure sensitive adhesive layer.

The silane coupling agent may include one or more of epoxysilane, mercaptosilane, vinyltrichlorosilane, vinyltrimethoxysilane, 3-glycidoxypropyltrimethoxysilane, 3-methacryloxypropyltrimethoxysilane, 2-aminoethyl-3-aminopropylmethyldimethoxysilane, or 3-ureidopropyltriethoxysilane.

The pressure sensitive adhesive layer may include an acrylic binder having vinyl groups, a heat curing agent, and a silane coupling agent.

The silane coupling agent may be present in an amount of 0.1 to 5% by weight, based on a solids content of the pressure sensitive adhesive layer.

The pressure sensitive adhesive layer may include 85 to 98.9% by weight of the acrylic binder having vinyl groups, 1 to 10% by weight of the heat curing agent, and 0.1 to 5% by weight of the silane coupling agent, based on a solids content of the pressure sensitive adhesive layer.

The acrylic binder having vinyl groups may have a weight average molecular weight of 150,000 g/mol to 700,000 g/mol.

The heat curing agent may be an isocyanate heat curing agent.

The silane coupling agent may include one or more of epoxysilane, mercaptosilane, vinyltrichlorosilane, vinyltrimethoxysilane, 3-glycidoxypropyltrimethoxysilane, 3-methacryloxypropyltrimethoxysilane, 2-aminoethyl-3-aminopropylmethyldimethoxysilane, or 3-ureidopropyltriethoxysilane.

The pressure sensitive adhesive layer may not include any photoinitiator.

### BRIEF DESCRIPTION OF THE DRAWINGS

Features will become apparent to those of skill in the art by describing in detail example embodiments with reference to the attached drawings in which:

FIG. 1 schematically illustrates wafer processing steps using a dicing die bonding film; and

FIG. 2 illustrates a dicing die bonding film according to an example embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey example implementations to those skilled in the art. In the drawing figures, the dimensions of layers and regions may be exaggerated for clarity of illustration. Like reference numerals refer to like elements throughout.

According to an example embodiment, a pressure sensitive dicing die bonding film includes a base film, a pressure sensitive adhesive layer formed on the base film, and a bonding layer formed on the pressure sensitive adhesive layer. An adhesive strength between the pressure sensitive adhesive layer and the bonding layer and an adhesive strength between the pressure sensitive adhesive layer and a ring frame may satisfy the following relation:

B/A≧1.1

where A is an adhesive strength between the pressure sensitive adhesive layer and the bonding layer and B is an adhesive strength between the pressure sensitive adhesive layer and a ring frame.

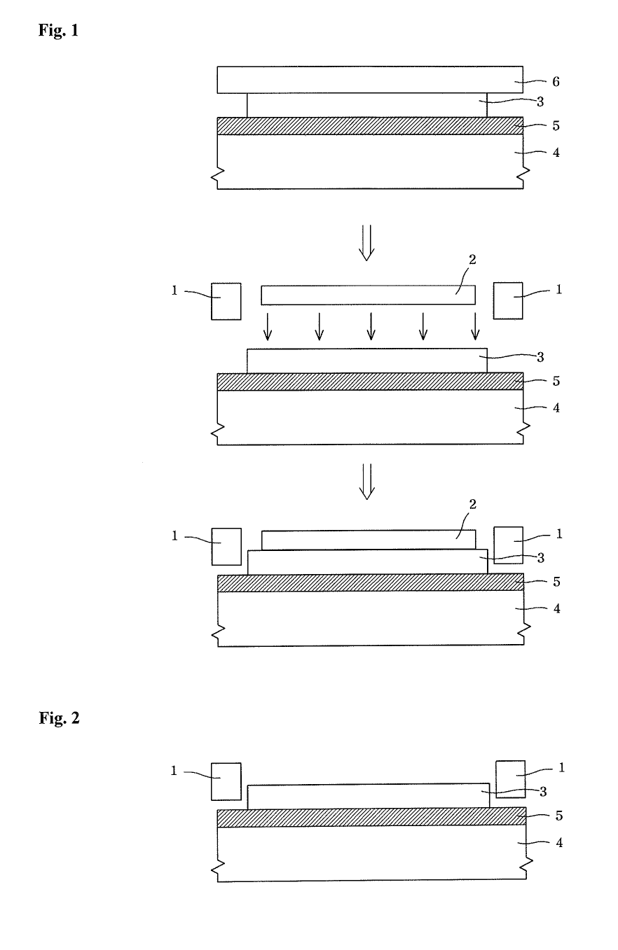

FIG. 1 schematically illustrates wafer processing steps using a general dicing die bonding film. The dicing die bonding film may include a base film 4, a pressure sensitive adhesive layer 5 on the base film, a bonding layer 3 on the pressure sensitive adhesive layer, and a release film 6 on the bonding layer. The release film may protect the bonding layer from external materials and may be used to facilitate winding in a roll form. First, the release film 6 is peeled off. Then, a wafer 2 is laminated on the bonding layer 3, and a ring frame 1 is laminated on the pressure sensitive adhesive layer 5, followed by dicing of the wafer. After dicing, the individual wafer chips are bonded, together with the bonding layer, to a support member such as a PCB or a lead frame.

If a pressure sensitive adhesive layer of a dicing die bonding film has a low adhesive strength, partial detachment of a ring frame from the pressure sensitive adhesive layer may occur during dicing process, due to a low adhesive strength between the pressure sensitive adhesive layer and the ring frame. This partial detachment may cause chips to be moved during dicing, thus increasing the risk of damage to the chips such as chip cracks. Further, the pressure sensitive adhesive layer may be detached from the ring frame during expansion (a process for applying a constant tension to the film in a fixed state of the ring frame to expand the film), resulting in the formation of defects throughout a wafer. Meanwhile, a high adhesive strength between the pressure sensitive adhesive layer and the bonding layer may make it difficult to separate the pressure sensitive adhesive layer from the bonding layer after dicing, which may lead to a low pick-up success rate.

FIG. 2 illustrates a dicing die bonding film according to an example embodiment. A dicing die bonding film according to an example embodiment has an adhesive strength A between a pressure sensitive adhesive layer 5 and a bonding layer 3, and an adhesive strength B between the pressure sensitive adhesive layer 5 and a ring frame 1, that satisfy the relation B/A≧1.1. In an example embodiment, the ratio B/A is from 1.2 to 3. Maintaining the ratio B/A at greater than or equal to 1.1 may help ensure that the ring frame remains attached during dicing process and remains stable. The ratio of the adhesive strength B between the pressure sensitive adhesive layer and a ring frame to the adhesive strength A between the pressure sensitive adhesive layer and the bonding layer to the range defined above may help prevent problems associated with conventional UV-curable and general pressure sensitive dicing die bonding films.

The adhesive strength A between the pressure sensitive adhesive layer and the bonding layer of the pressure sensitive dicing die bonding film may be measured by suitable methods known in the art. For example, the adhesive strength A may be measured in accordance with Korean Industrial Standard KS-A-01107 (8). Specifically, the dicing die bonding film is pressed by one reciprocation of a press roller under a load of 2 kg at a rate of 300 mm/min. Thirty minutes after pressing, a portion of the test piece is folded, flipped over, and peeled (˜25 mm). The test piece is positioned on an upper clip of a tensile tester (Instron Series 1×/s Automated Materials Tester-3343) and the die bonding film is fixed to a lower clip of the tensile tester. A load required to peel the die bonding film by pulling at a tensile rate of 300 mm/s is measured. The load is defined as the adhesive strength A.

The adhesive strength A between the pressure sensitive adhesive layer and the bonding layer of the pressure sensitive dicing die bonding film may be from 0.15 to 0.25 N/25 mm, as measured in accordance with Korean Industrial Standard KS-A-01107 (8).

The adhesive strength B between the pressure sensitive adhesive layer of the pressure sensitive dicing die bonding film and a ring frame may be measured by suitable methods known in the art. For example, the adhesive strength B may be measured by the following procedure. First, the dicing film is pressed by one reciprocation of a press roller under a load of 2 kg at a rate of 300 mm/min. Thirty minutes after pressing, a portion of the test piece is folded, flipped over, and peeled (˜25 mm). The test piece is positioned on an upper clip of a tensile tester (Instron Series 1×/s Automated Materials Tester-3343) and the dicing film is fixed to a lower clip of the tensile tester. A load required to peel the dicing film by pulling at a tensile rate of 300 mm/s is measured. The load is defined as the adhesive strength B.

The adhesive strength B between the pressure sensitive adhesive layer of the pressure sensitive dicing die bonding film and a ring frame may be from 0.18 to 0.40 N/25 mm, as measured by the above procedure.

The pressure sensitive adhesive layer of the pressure sensitive dicing die bonding film may have a shift distance of 0 to 0.1 mm in a creep test when a force of 10 gf/mm² is applied thereto for 1,000 seconds. Within this range, the adhesive strength between the pressure sensitive adhesive layer and a ring frame is sufficiently high to prevent the ring frame from being detached from the pressure sensitive adhesive layer. Preferably, the shift distance may be 0.02 to 0.03 mm.

The pressure sensitive adhesive layer of the pressure sensitive dicing die bonding film may have a monolayer structure. To allow a pressure sensitive adhesive layer of a dicing die bonding film to have different adhesive strengths between a bonding layer and a ring frame, another pressure sensitive adhesive layer may be added between the pressure sensitive adhesive layer and the ring frame. In an embodiment, the pressure sensitive adhesive layer of the dicing die bonding film has a monolayer structure, which may provide for easier production and processing. The thickness of the pressure sensitive adhesive layer may be in the range of, e.g., 3 μm to 40 μm. In an implementation, the pressure sensitive adhesive layer may have a thickness of 5 μm to 30 μm.

In an example embodiment, the pressure sensitive adhesive layer of the pressure sensitive dicing die bonding film may include an acrylic binder having vinyl groups, a heat curing agent, and a silane coupling agent.

Acrylic Binder Having Vinyl Groups

The acrylic binder having vinyl groups may be prepared by, e.g., polymerizing an acrylic monomer (e.g., an acrylic monomer that imparts adhesiveness to the pressure sensitive adhesive layer) as a main monomer with a functional acrylic monomer in the presence of a polymerization initiator. For example, the pressure sensitive adhesive layer may be formed using an acrylic polyol resin prepared by polymerizing an acrylic monomer with a functional acrylic monomer in the presence of a polymerization initiator.

The acrylic monomer may impart adhesiveness to the film. The acrylic monomer may include, e.g., a C₄-C₂₀ acrylic acid ester or methacrylic acid ester. Specific examples of such acrylic monomers include 2-ethyl hexyl (meth)acrylate, isooctyl (meth)acrylate, ethyl (meth)acrylate, n-butyl (meth)acrylate, isobutyl (meth)acrylate, and octadecyl (meth)acrylate. These acrylic monomers may be used alone or as a mixture of two or more thereof. In an implementation, the acrylic monomer has a glass transition temperature of −70° C. to −30° C.

The acrylic monomer may be included in an amount of 60 to 84% by weight, based on the total weight of all monomers constituting the acrylic binder. Within this range, the acrylic monomer may determine the Tg and modulus of the pressure sensitive adhesive binder. The content of the acrylic monomer may be from 65 to 79% by weight, e.g., 70 to 79% by weight. In an implementation, 2-ethyl hexyl acrylate having a low Tg may be used as the acrylic monomer for its ability to improve the tackiness of the pressure sensitive adhesive binder.

The functional acrylic monomer may include one or more of, e.g., a monomer having at least one hydroxyl group, a monomer containing at least one epoxy group, a reactive monomer, etc. In an implementation, a combination of a monomer having a hydroxyl group and a monomer containing an epoxy group may be used as the functional acrylic monomer.

The monomer having a hydroxyl group may include one or more of, e.g., a C₄-C₂₀ acrylic acid ester having at least one hydroxyl group, a C₄-C₂₀ methacrylic acid ester having at least one hydroxyl group, other compound having at least one hydroxyl group, etc. In an implementation, the monomer having a hydroxyl group may include one or more of hydroxymethyl (meth)acrylate, 2-hydroxyethyl (meth)acrylate, 4-hydroxybutyl (meth)acrylate, hydroxypropyl (meth)acrylate, vinylcaprolactam, etc.

The monomer having a hydroxyl group may be included in an amount of 15 to 25% by weight, based on the total weight of all monomers constituting the acrylic binder. Within this range, adhesion of the pressure sensitive adhesive layer to a ring frame may be improved without negatively affecting a pick-up process. In an implementation, the monomer having a hydroxyl group may be included in an amount of 20 to 25% by weight.

The monomer containing an epoxy group may include, e.g., a C₄-C₂₀ acrylic acid ester containing at least one epoxy group, a C₄-C₂₀ methacrylic acid ester containing at least one epoxy group, other compounds containing at least one epoxy group, etc. In an implementation, the monomer containing an epoxy group may include one or more of glycidyl acrylate and glycidyl methacrylate.

The monomer containing an epoxy group may be included in an amount of 1 to 10% by weight, based on the total weight of all monomers constituting the acrylic binder. This range is advantageous for a pick-up process. In an implementation, the monomer containing an epoxy group may be included in an amount of 1 to 5% by weight.

In an implementation, the reactive monomer may include one or more monomers having at least 10 carbon atoms. The reactive monomer may include, e.g., lauryl (meth)acrylate, stearyl (meth)acrylate, cetyl (meth)acrylate, octadecyl (meth)acrylate, etc.

The reactive monomer may be included in an amount of 0 to 5% by weight, based on the total weight of all monomers constituting the acrylic binder. Within this range, the releasability of the pressure sensitive adhesive binder may be enhanced, which may be advantageous for a pick-up process.

The polymerization initiator may be a radical generator. Such radical generators include, e.g., azobis compounds, such as azobisisobutyronitrile; and organic peroxides, such as benzoyl peroxide. The polymerization initiator may be included in an amount of 0.1 to 1.0 parts by weight, based on 100 parts by weight of all monomers included in the acrylic binder. In an implementation, the polymerization initiator may be included in an amount of 0.2 to 0.6 parts by weight. In an implementation, the polymerization initiator may be used in combination with a catalyst or a polymerization inhibitor.

The polymerization may be performed at a temperature of, e.g., 80 to 120° C. for, e.g., 1 to 70 hr. The polymerization time may be, e.g., from 5 to 15 hr.

The acrylic binder having vinyl groups may be included in an amount of 85 to 98.9% by weight, based on the solids content of the pressure sensitive adhesive layer. Within this range, a uniform adhesive strength may be obtained. In an implementation, the content of the acrylic binder may be from 90 to 95.8% by weight.

The acrylic binder having vinyl groups may have a weight average molecular weight of 150,000 to 700,000 g/mol. Within this range, the pressure sensitive adhesive may be readily adhered to the substrate and may be mass produced without being transferred to a ring frame or the adhesive.

Heat Curing Agent

Heat curing agents suitable for use in the production of the pressure sensitive adhesive layer may include, e.g., isocyanate heat curing agents, such as 2,4-trilene diisocyanate, 2,6-trilene diisocyanate, hydrogenated trilene diisocyanate, 1,3-xylene diisocyanate, 1,4-xylene diisocyanate, diphenyl methane-4,4-diisocyanate, 1,3-bisisocyanatomethylcyclohexane, tetramethylxylene diisocyanate, 1,5-naphthalene diisocyanate, 2,2,4-trimethylhexamethylene diisocyanate, 2,4,4-trimethylhexamethylene diisocyanate, trilene diisocyanate adducts of trimethylolpropane, xylene diisocyanate adducts of trimethylolpropane, triphenylmethane triisocyanate, methylene bistriisocyanate, etc. These heat curing agents may be used alone or as a mixture of two or more thereof.

The heat curing agent may be included in an amount of 1 to 10% by weight, based on the solids content of the pressure sensitive adhesive layer. Within this range, the heat curing agent may maintain the adhesive strength between the pressure sensitive adhesive layer and a ring frame, and may allow the pressure sensitive adhesive layer to be advantageously applied to a pick-up process. In an implementation, the content of the heat curing agent may be from 4 to 8% by weight.

Silane Coupling Agent

In addition to the acrylic binder having vinyl groups and the heat curing agent, the pressure sensitive adhesive layer may include a silane coupling agent.

The use of the silane coupling agent may stabilize a ring frame and the pressure sensitive adhesive layer when a wafer is mounted on the dicing die bonding film and is diced. The use of an excess amount of the heat curing agent in the absence of the silane coupling agent may deteriorate the stability of a ring frame and the pressure sensitive adhesive layer, and a specially processed ring frame may be used in a general pressure sensitive dicing die bonding film that does not undergo UV processing, which may entail high cost and complicate the overall procedure. In contrast, the use of the silane coupling agent may help ensure good stability of a ring frame and the pressure sensitive adhesive film without further processing of the ring frame. In addition, a creep similar to that of a UV-curable film may be obtained.

The silane coupling agent may be included in an amount of 0.1 to 5% by weight, based on the solids content of the pressure sensitive adhesive layer. Within this range, the ratio B/A may be maximally maintained. In an implementation, the silane coupling agent may be included in an amount of 0.2 to 2% by weight.

The silane coupling agent may include, e.g., one or more of epoxysilane, mercaptosilane, aminosilane, vinyltrichlorosilane, vinyltrimethoxysilane, 3-glycidoxypropyltrimethoxysilane, 3-methacryloxypropyltrimethoxysilane, 2-aminoethyl-3-aminopropylmethyldimethoxysilane, 3-ureidopropyltriethoxysilane, etc.

The pressure sensitive adhesive layer may be formed using a solvent to facilitate coating on or transfer to the base film. The solvent may be any suitable solvent, e.g., methyl ethyl ketone. The amount of the solvent used may be, e.g., 70 to 80 parts by weight, based on 100 parts by weight of the solids content of the pressure sensitive adhesive layer.

In an example embodiment, the pressure sensitive adhesive layer does not include any photoinitiator. A pressure sensitive adhesive layer of a general UV irradiation type dicing die bonding film includes a photoinitiator to cure the pressure sensitive adhesive layer, in order to separate the pressure sensitive adhesive layer from a bonding layer. In contrast, the pressure sensitive dicing die bonding film according to an embodiment does not need to undergo UV irradiation, thus eliminating the need to use a photoinitiator.

The pressure sensitive adhesive layer seizes a wafer to prevent the wafer from moving during dicing. The base film serves to support the pressure sensitive adhesive layer. The base film may be a film that is stretchable at room temperature so as to enable an expansion process, which is carried out to increase the intervals between individual chips after completion of dicing in order to facilitate pick-up of the chips.

Various polymeric materials may be used for the base film. For example, a thermoplastic plastic film may be used as the base film. A thermoplastic film may be sufficiently expandable to enable pick up of chips after dicing; chips remaining after expansion may be picked up after passage of time. A thermoplastic film may be suitable for use as the base film due to its ability to restore. Examples of polymeric materials suitable for the base film include polyolefins, such as polyethylene, polypropylene, ethylene/propylene copolymers, polybutene-1, ethylene/vinyl acetate copolymers, polyethylene/styrene butadiene rubber blends, and polyvinyl chloride. Polymers such as polyethylene terephthalate, polycarbonate, and poly(methyl methacrylate), thermoplastic elastomers such as polyurethane and polyamide-polyol copolymers, and mixtures thereof may also be used. The thickness of the base film may be from 30 μm to 300 μm, e.g., from 50 μm to 200 μm, in terms of elongation and workability.

The pressure sensitive adhesive layer may be formed on the base film by a suitable technique. For example, the pressure sensitive adhesive layer may be directly formed on the base film by coating. In another implementation, the pressure sensitive adhesive layer may be formed on a release film by coating, dried, and transferred to the base film. In either case, a technique suitable for forming uniform coating layers may be used to form the pressure sensitive adhesive layer. Bar coating, gravure coating, comma coating, reverse roll coating, applicator coating, spray coating, and dip coating may be used. The pressure sensitive adhesive layer may have a thickness of 3 to 40 μm, e.g., 5 to 30 μm.

The bonding layer of the pressure sensitive dicing die bonding film may be in the form of a film and may be formed of a heat curable composition. The bonding layer may be selected to provide good adhesion to a ground backside of a wafer. The bonding layer may be composed of heat curable resins and a curing agent. The heat curable resins may include an acrylic copolymer and an epoxy resin that have a high molecular weight and have the ability to form a film. An example of the acrylic copolymer is an acrylic rubber, which may be a copolymer of an acrylic acid ester or a methacrylic acid ester and acrylonitrile. The epoxy resin may be a suitable resin that has a high adhesive strength after curing. The epoxy resin may have two or more functional groups for curing. Examples of such epoxy resins include bisphenol A epoxy resins, phenol novolac epoxy resins, and cresol novolac epoxy resins. The curing agent may be a suitable agent for the formation of adhesive layers.

A curing accelerator may be used to cure the epoxy resin. The curing accelerator may be of imidazole or amine type. One or more kinds of silane coupling agents may be used to increase the adhesion to a wafer.

A suitable coating technique for obtaining a uniform coating thickness may be used to form the bonding layer. The coating technique for forming the pressure sensitive adhesive layer may also be used to form the bonding layer. The bonding layer may have a coating thickness of 5 to 100 μm, e.g., 10 to 80 μm.

The dicing die bonding film may have a release film to protect the bonding layer from foreign matter and to facilitate winding in a roll form.

The dicing die bonding film may have a structure in which the pressure sensitive adhesive layer is formed on the base film and the bonding layer is laminated on the pressure sensitive adhesive layer. A semiconductor wafer or chip may be attached to the bonding layer and may be diced into chips having smaller sizes. The chips may be easily peeled from the underlying pressure sensitive adhesive layer when being picked up. The picked-up chips may be bonded to the surface of a support member such as a PCB or a lead frame (‘die bonding’). At this time, the bonding layer may be attached to the backsides of the chips.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLES

### Preparative Example 1

### Preparation of Acrylic Binder

500 g of ethyl acetate was placed in a 2 L four-neck flask equipped with a reflux condenser, a thermometer, and a dropping funnel. The temperature was raised to 77° C. 390 g of 2-ethyl hexyl acrylate, 60 g of isooctyl acrylate, 60 g of 2-hydroxyethyl methacrylate, 60 g of 2-hydroxyethyl acrylate, 30 g of glycidyl methacrylate, and 0.15 g of azobisisobutyronitrile were mixed. The mixture was added dropwise to the flask through the dropping funnel at 77° C. for 3 hr with stirring at 200 rpm. After the dropwise addition was finished, the resulting mixture was allowed to react at 86° C. for 4 hr. A mixture of 150 g of ethyl acetate and 0.15 g of azobisisobutyronitrile was added to the flask for 20 min and left standing at 82° C. for 4 hr, yielding an acrylic binder having a viscosity at 25° C. of 2,540 cps.

### Preparative Example 2

### Preparation of UV-Curable Acrylic Binder

100 parts by weight of a solid of the acrylic binder prepared in Preparative Example 1 was put into a 2 L four-neck flask, and then 130 parts by weight of ethyl acetate and 120 parts by weight of toluene were added thereto. 20 parts by weights of 2-isocyanatoethyl methacrylate and 30 ppm DBTDL were added to the flask. The mixture was stirred at 300 rpm at 55° C. for 8 hr. The disappearance of the isocyanate groups as a result of the reaction between the acrylic binder and the 2-isocyanatoethyl methacrylate was confirmed by FT-IR. Ethyl acetate was added to cool the reaction mixture, yielding a UV-curable acrylic binder.

Details of components used in Examples 1-8 and Comparative Examples 1-3 are as follows:

1. Acrylic binders: As prepared in Preparative Examples 1 and 2

2. Heat curing agents: Isocyanate curing agent (AK-75, Aekyung Chemical, ‘Curing agent 1’) and isocyanate curing agent (TKA-10, Asahi Kasei Corporation, ‘Curing agent 2’)

3. Silane coupling agents: KBM-803 (Shin-Etsu Chemical Co., Ltd., ‘Coupling agent 1’) and KBM-403 (Shin-Etsu Chemical Co., Ltd., ‘Coupling agent 2’)

4. Photoinitiator: Darocur 1173 (Ciba Chemical)

5. Solvent: Methyl ethyl ketone

### Examples 1-8

### Production of Pressure Sensitive Dicing Die Bonding Films

The acrylic binder prepared in Preparative Example 1, the corresponding heat curing agent, the corresponding silane coupling agent, and the solvent (methyl ethyl ketone) were mixed in the amounts as shown in Table 1. Each of the mixtures was stirred at 25° C. for 1 hr to prepare a pressure sensitive adhesive composition. The pressure sensitive adhesive composition was coated to a thickness of 10 μm on a PET film, transferred to a polyolefin film as a base film, and aged at 25° C. for 3 days. The aged sample (25 mm×250 mm) was attached to a 20 μm thick adhesive layer, on which a PET film had been formed, to produce a dicing die bonding film.

### Comparative Examples 1-2

### Production of Pressure Sensitive Dicing Die Bonding Films

The acrylic binder prepared in Preparative Example 1, the heat curing agent, and the solvent (methyl ethyl ketone) were mixed in the amounts as shown in Table 1. Each of the mixtures was stirred at 25° C. for 1 hr to prepare a pressure sensitive adhesive composition. Thereafter, the procedure of Examples 1-8 was repeated to produce a dicing die bonding film.

### Comparative Example 3

### Production of UV Irradiation Type Dicing Die Bonding Film

The acrylic binder prepared in Preparative Example 2, the heat curing agent, the photoinitiator, and the solvent (methyl ethyl ketone) were mixed in the amounts as shown in Table 1. The mixture was stirred at 25° C. for 1 hr to prepare a pressure sensitive adhesive composition. Thereafter, the procedure of Examples 1-8 was repeated to produce a dicing die bonding film.

TABLE 1

| | | | | | | | | | | Comparative | | |
|---|---|---|---|---|---|---|---|---|---|---|---|---|
| | | Examples | | | | | | | | Examples | | |
| | | 1 | 2 | 3 | 4 | 5 | 6 | 7 | 8 | 1 | 2 | 3 |
| Acrylic | Prep. | 94.08 | 92.82 | 92.73 | 92.82 | 94.94 | 94.08 | 93.98 | 94.08 | 94.28 | 93.02 | — |
| binders | Ex. 1 | | | | | | | | | | | |
| | Prep. | — | — | — | — | — | — | — | — | — | — | 96.42 |
| | Ex. 2 | | | | | | | | | | | |
| Heat | Curing | 5.72 | 6.98 | 6.97 | 6.98 | — | — | — | — | 5.72 | 6.98 | 3.03 |
| curing | agent 1 | | | | | | | | | | | |
| agents | Curing | — | — | — | — | 4.86 | 5.72 | 5.71 | 5.72 | — | — | — |
| | agent 2 | | | | | | | | | | | |
| Silane | Coupling | 0.2 | 0.2 | 0.3 | — | 0.2 | 0.2 | 0.31 | — | — | — | — |
| coupling | agent 1 | | | | | | | | | | | |
| agents | Coupling | — | — | — | 0.2 | — | — | — | 0.2 | — | — | — |
| | agent 2 | | | | | | | | | | | |

| | | | | | | | | | | | |
|---|---|---|---|---|---|---|---|---|---|---|---|
| Photoinitiator | — | — | — | — | — | — | — | — | — | — | 0.55 |
| Solvent | 75 | 75 | 75 | 75 | 75 | 75 | 75 | 75 | 75 | 75 | 75 |

Note:
In Table 1, the amounts of the components are given in parts by weight.

### Experimental Example 1

### Measurement of Physical Properties of the Pressure Sensitive Adhesive Compositions

The physical properties of the pressure sensitive adhesive compositions prepared in Examples 1-8 and Comparative Examples 1-3 were measured by the following methods. The results are shown in Table 2.

1. Adhesive strength between the pressure sensitive adhesive layer and the bonding layer: The adhesive strength measurement was conducted in accordance with Korean Industrial Standard KS-A-01107 (8). Specifically, each of the dicing die bonding films produced in Examples 1-8 and Comparative Examples 1-3 was pressed by one reciprocation of a press roller under a load of 2 kg at a rate of 300 mm/min. Thirty minutes after pressing, a portion of the test piece was folded, flipped over by 180 degree, and peeled (˜25 mm). The test piece was positioned on an upper clip of a tensile tester (Instron Series 1×/s Automated Materials Tester-3343) and the die bonding film was fixed to a lower clip of the tensile tester. A load required to peel the die bonding film by pulling at a tensile rate of 300 mm/s was measured. The dicing die bonding film of Comparative Example 3 was irradiated with UV at an exposure dose of 200 mJ/cm².

2. Adhesive strength between the pressure sensitive adhesive layer and a ring frame: Each of the dicing films produced in Examples 1-8 and Comparative Examples 1-3 was pressed by one reciprocation of a press roller under a load of 2 kg at a rate of 300 mm/min. Thirty minutes after pressing, a portion of the test piece was folded, flipped over by 180 degree, and peeled (˜25 mm). The test piece was positioned on an upper clip of a tensile tester (Instron Series 1×/s Automated Materials Tester-3343) and the dicing film was fixed to a lower clip of the tensile tester. A load required to peel the dicing film by pulling at a tensile rate of 300 mm/s was measured.

3. Creep: Each of the dicing films aged in Examples 1-8 and Comparative Examples 1-3 was attached to an area (1.5 cm×1.5 cm) of a glass plate and was left to stand at 25° C. for 1 day. When a force of 10 gf/mm² was applied to the specimen using a universal test machine (UTM) for 1,000 sec, the pushed distance of the specimen was measured.

4. Tackiness: The tackiness measurement was conducted pursuant to ASTM D2979-71. Specifically, after the tip of a probe was brought into contact with each of the pressure sensitive adhesive portions of the test pieces produced above at a rate of 10±0.1 mm/sec under a contact load of 9.79+1.01 kPa for 1.0±0.01 sec, the maximum force required to separate the tip from the pressure sensitive adhesive portion was measured. The dicing die bonding film of Comparative Example 3 was irradiated with UV at an exposure dose of 200 mJ/cm².

5. Adhesive strength to the base film: Each of the pressure sensitive adhesive layers of the dicing die bonding films produced in Examples 1-8 and Comparative Examples 1-3 was cross-cut at horizontal and vertical intervals of 1 mm to form a total of one hundred blocks. After an adhesive tape was attached on the blocks and was pulled suddenly, the peeling state of the blocks was checked to evaluate the adhesive strength to the base film. In Table 2, ‘100/100’ signifies that all blocks remained attached.

6. Stability of ring frame after dicing: The dicing die bonding films produced in Examples 1-8 and Comparative Example 1-3 were diced under the following conditions:

Apparatus: DISCO Dicer DFD-6361; Rotation of blade: 50,000 rpm; Blade velocity: 50 mm/sec; Thickness of dicing film: 110 μm; Cutting depth into dicing film: 15 μm.

The stability of the ring frame was judged based on the following three criteria:

∘: 95-100% of the overall area between the ring frame and the pressure sensitive adhesive layer remained attached;
Δ: 80-95% of the overall area between the ring frame and the pressure sensitive adhesive layer remained attached;
x: Less than 85% of the overall area between the ring frame and the pressure sensitive adhesive layer remained attached.

Pick-up success rate: After the PET film was removed from each of the dicing die bonding films produced in Examples 1-8 and Comparative Example 1-3, a wafer was mounted and diced into chips. 200 chips in the central portion of the wafer were picked up using a die bonder (SDB-10M, Mechatronics), and the pick-up success rate for the chips was measured.

TABLE 2

| | | Examples | | | | | | | | Comparative Examples | | |
|---|---|---|---|---|---|---|---|---|---|---|---|---|
| | | 1 | 2 | 3 | 4 | 5 | 6 | 7 | 8 | 1 | 2 | 3 |
| Adhesive | Before | 0.218 | 0.153 | 0.150 | 0.162 | 0.245 | 0.197 | 0.189 | 0.184 | 0.209 | 0.159 | 1.146 |
| strength | photo- | | | | | | | | | | | |
| A*¹ | curing | | | | | | | | | | | |
| | After | n/a | n/a | n/a | n/a | n/a | n/a | n/a | n/a | n/a | n/a | 0.052 |
| | photo- | | | | | | | | | | | |
| | curing | | | | | | | | | | | |
| Adhesive strength | | 0.286 | 0.216 | 0.281 | 0.201 | 0.312 | 0.243 | 0.329 | 0.226 | 0.195 | 0.152 | 1.035 |
| B*² | | | | | | | | | | | | |
| B/A | | 1.31 | 1.41 | 1.87 | 1.24 | 1.27 | 1.23 | 1.74 | 1.23 | 0.93 | 0.96 | 0.90 |
| Creep (mm) | | 0.02 | 0.03 | 0.02 | 0.03 | 0.02 | 0.03 | 0.02 | 0.03 | 0.84 | Detached | 0.02 |
| Adhesive | Before | 59 | 50 | 51 | 56 | 63 | 55 | 60 | 55 | 40 | 37 | 129 |
| strength | photo- | | | | | | | | | | | |
| (gf) | curing | | | | | | | | | | | |
| | After | n/a | n/a | n/a | n/a | n/a | n/a | n/a | n/a | n/a | n/a | 19 |
| | photo- | | | | | | | | | | | |
| | curing | | | | | | | | | | | |

| | | | | | | | | | | | |
|---|---|---|---|---|---|---|---|---|---|---|---|
| Adhesive strength to | 100/ | 100/ | 100/ | 100/ | 100/ | 100/ | 100/ | 100/ | 100/ | 100/ | 100/ |
| base film | 100 | 100 | 100 | 100 | 100 | 100 | 100 | 100 | 100 | 100 | 100 |
| Stability of ring | ∘ | ∘ | ∘ | ∘ | ∘ | ∘ | ∘ | ∘ | Δ | x | ∘ |
| frame | | | | | | | | | | | |
| Pick-up success rate | 100 | 100 | 100 | 100 | 100 | 100 | 100 | 100 | 100 | — | 100 |
| (%) | | | | | | | | | | | |

Notes:
*¹Adhesive strength (N/25 mm) between the bonding layer and the pressure sensitive adhesive layer;
*²Adhesive strength (N/25 mm) between the pressure sensitive adhesive layer and the ring frame.

As may be seen from the results in Table 2, the dicing die bonding films of Comparative Examples 1-2, each of which included no silane coupling agent, showed poor stability of the ring frames on the pressure sensitive adhesive layers during dicing. Particularly, when the content of the heat curing agent was increased without using any silane coupling agent, the stability of the ring frames worsened and the pick-up success rates were lowered. In contrast, the pressure sensitive dicing die bonding films according to the Examples showed better stability of the ring frames and higher pick-up success rates. In addition, the pressure sensitive dicing die bonding films according to the Examples had almost the same performance, including creep, as the UV-curable dicing die bonding film.

By way of summation and review, dicing die bonding films may be broadly divided into two types: UV-curable and general pressure sensitive types. In the case of the former type, curing of a pressure sensitive adhesive layer by UV irradiation after dicing is used to lower the peel strength between the pressure sensitive adhesive layer and an overlying adhesive layer to make it easier to pick up a die, for example, a die having a thickness of 80 μm or less, in a subsequent process. However, the UV irradiation may require a large amount of time and entail an increase in cost. There is thus a need for a pressure sensitive dicing die bonding film that possesses the performance of a UV-curable dicing die bonding film without undergoing further processing, such as ring frame coating.

As described above, embodiments relate to a pressure sensitive dicing die bonding film which includes a pressure sensitive adhesive layer. The dicing die bonding film may include a pressure sensitive adhesive layer having different adhesive strengths to a ring frame and a bonding layer. The dicing die bonding film may include a pressure sensitive adhesive layer having an adhesive strength to a ring frame and an adhesive strength to a bonding layer in a specific ratio, which may help avoid the need for additional processing, such as ring frame coating, and avoid time and cost for UV irradiation.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. A pressure sensitive dicing die bonding film, comprising:
a base film;
a pressure sensitive adhesive layer formed on the base film; and
a bonding layer formed on the pressure sensitive adhesive layer, wherein:
an adhesive strength between the pressure sensitive adhesive layer and the bonding layer and an adhesive strength between the pressure sensitive adhesive layer and a ring frame satisfy the following relation:
B/A≧1.1
where A is the adhesive strength between the pressure sensitive adhesive layer and the bonding layer, and B is the adhesive strength between the pressure sensitive adhesive layer and the ring frame.

2. The pressure sensitive dicing die bonding film as claimed in claim 1, wherein said pressure sensitive adhesive layer has a shift distance of 0 mm to 0.1 mm in a creep test when a force of 10 gf/mm² is applied thereto for 1,000 seconds.

3. The pressure sensitive dicing die bonding film as claimed in claim 1, wherein said pressure sensitive adhesive layer has a monolayer structure.

4. The pressure sensitive dicing die bonding film as claimed in claim 1, wherein said pressure sensitive adhesive layer has a thickness of 3 μm to 40 μm.

5. The pressure sensitive dicing die bonding film as claimed in claim 1, wherein said pressure sensitive adhesive layer includes a silane coupling agent.

6. The pressure sensitive dicing die bonding film as claimed in claim 5, wherein said silane coupling agent is present in an amount of 0.1 to 5% by weight, based on a solids content of the pressure sensitive adhesive layer.

7. The pressure sensitive dicing die bonding film as claimed in claim 5, wherein said silane coupling agent includes one or more of epoxysilane, mercaptosilane, vinyltrichlorosilane, vinyltrimethoxysilane, 3-glycidoxypropyltrimethoxysilane, 3-methacryloxypropyltrimethoxysilane, 2-aminoethyl-3-aminopropylmethyldimethoxysilane, or 3-ureidopropyltriethoxysilane.

8. The pressure sensitive dicing die bonding film as claimed in claim 1, wherein said pressure sensitive adhesive layer includes:
an acrylic binder having vinyl groups,
a heat curing agent, and
a silane coupling agent.

9. The pressure sensitive dicing die bonding film as claimed in claim 8, wherein said silane coupling agent is present in an amount of 0.1 to 5% by weight, based on a solids content of the pressure sensitive adhesive layer.

10. The pressure sensitive dicing die bonding film as claimed in claim 8, wherein said pressure sensitive adhesive layer includes:
85 to 98.9% by weight of the acrylic binder having vinyl groups,
1 to 10% by weight of the heat curing agent, and
0.1 to 5% by weight of the silane coupling agent,
based on a solids content of the pressure sensitive adhesive layer.

11. The pressure sensitive dicing die bonding film as claimed in claim 8, wherein said acrylic binder having vinyl groups has a weight average molecular weight of 150,000 g/mol to 700,000 g/mol.

12. The pressure sensitive dicing die bonding film as claimed in claim 8, wherein said heat curing agent is an isocyanate heat curing agent.

13. The pressure sensitive dicing die bonding film as claimed in claim 8, wherein said silane coupling agent includes one or more of epoxysilane, mercaptosilane, vinyltrichlorosilane, vinyltrimethoxysilane, 3-glycidoxypropyltrimethoxysilane, 3-methacryloxypropyltrimethoxysilane, 2-aminoethyl-3-aminopropylmethyldimethoxysilane, or 3-ureidopropyltriethoxysilane.

14. The pressure sensitive dicing die bonding film as claimed in claim 8, wherein said pressure sensitive adhesive layer does not include any photoinitiator.

15. The pressure sensitive dicing die bonding film as claimed in claim 1, wherein said pressure sensitive adhesive layer does not include any photoinitiator.
